(19) United States
(12) Patent Application Publication
(10) Pub. No.: US 2010/0201207 A1
(43) Pub. Date: Aug. 12, 2010

(54) APPARATUS FOR CONTROLLING ELECTRICAL POWER DISTRIBUTION TO CHARGING DEVICES

(76) Inventors: Bruce Barton, Huntington, NY (US); Russell Barton, Northport, NY (US)

Correspondence Address: EDWIN D. SCHINDLER, FIVE HIRSCH AVENUE, P.O. BOX 966, CORAM, NY, 11727-0966, US

(21) Appl. No.: 12/367,238

(22) Filed: Feb. 6, 2009

(51) Int. Cl. H01H 47/00

(52) U.S. Cl. 307/125; 307/38

(57) ABSTRACT

An apparatus for controlling electrical power distribution to an electrical charging device includes a power input that is to be connected to a power source for receiving electrical current from the power source and a power output that is to be connected to at least one electrical charging device having a run mode and a standby mode for supplying the electrical current to the one or more electrical charging devices. A device for sensing when the electrical current to the electrical charging device is below a predetermined threshold, when the electrical charging device is in the standby mode, and for sensing when the electrical current is above the predetermined threshold when the electrical charging device is in the run mode is provided, along with a device for interrupting the electrical current to the electrical charging device when the electrical current falls below the predetermined threshold as the electrical charging device transitions from the run mode to the standby mode as determined by the sensing device. A further device resets and powers the electrical charging device when the electrical current increases above the predetermined threshold as the electrical charging device transitions from the standby mode to the run mode as deter-mined by the sensing device.

### BACKGROUND OF THE INVENTION

1. Technical Field of the Invention

The present invention relates, generally, to an apparatus for controlling a distribution of electrical power to subsystems, e.g., to a charging device or devices.

More particularly, the present invention relates to an apparatus for controlling a distribution of power formed as an electrical power strip and power control sensors, which can be used mainly with devices having two of modes of operation, e.g., idle and full “on”.

2. Description of the Prior Art

One type of an electrical distribution device known to the art is the power strip or power control center, which generally comprises of a row of power outlets, that can be either switched or unswitched, for distributing power to a primary device and one or more secondary devices from a standard outlet (e.g., wall outlet.) Some of these known power strips and control centers contain various options, such as, circuit breakers, fuses and/or surge protectors.

In many newer personal computer systems, the system can shut itself “off” upon command from the operating system. During system shutdown, there is a delay during which the operator must wait for the personal computer system to complete its shutdown before proceeding to separately turn off secondary devices, such as printers and monitors. Depending upon the operating software and application programs, this waiting period can be significant. The present invention, as detailed hereinafter, proceeds to turn off the secondary, or peripheral, devices after a user directs the operating system of the computer system to commence shutdown of the computer; the user not being required to await shutdown of the computer before proceeding to separately turn off the secondary devices.

Various improvements over the devices disclosed and suggested by the foregoing references are disclosed in the inventors' U.S. Pat. No. 6,501,195; U.S. Pat. No. 6,528,902; U.S. Pat. No. 6,759,762; U.S. Pat. No. 6,759,763; and P.C.T. Application Publication No. WO 2006/022632.

### SUMMARY OF THE INVENTION

It is, therefore, an object of the present invention to provide an apparatus for controlling the distribution of electrical power to devices with a standby mode, for example, charging devices, that draws full power when first plugged in for rapid charging of the battery and switches to an idle mode when charging has finished.

It is a further object of the present invention to provide an apparatus for controlling the distribution of electrical power to charging devices.

The foregoing and related objects are accomplished by the present invention, which provides an apparatus for controlling a power distribution to subsystems that includes a power input that is to be connected to a power source and a power output to be connected to one or more electrical charging devices. Means for sensing is included for sensing when a current level falls below a predetermined threshold, in response to the device(s) switching to an idle mode, or deactivated mode, as well as for sensing when the current level is above the predetermined threshold in response to the device still in run mode. Interrupting means is connected with the sensing means and operative for interrupting a power supply to, at least, one electrical charging device when the sensing means senses that the current level has fallen below the threshold. Starting, or resetting, means is able to supply power to one or more devices when activated or when the current level is above the predetermined threshold.

Low current operating device is included for increasing the voltage required for triggering the resetting means, despite there being a relatively small output of the sensing means, with the lower current operating device being capable of increasing the voltage of the resetting means without negatively affecting the sensing means. The low current operating device, in a preferred embodiment, uses a voltage reference for preventing a triggering level change with source voltage changes.

Also in accordance with the present invention, a low current operating voltage increasing means includes a voltage divider or voltage reference means.

In accordance with a further embodiment of the present invention, the sensing means can be formed as a current sensing coil or transformer arranged to the input of the triggering device and, at one side, connected to the voltage increasing means.

The starting, or resetting, means can, for example, be formed as a DC relay, an AC relay or as a solid state AC relay.

When the present invention is used in connection with a charging system, each charger is plugged into a separate outlet. The device(s) to be charged are connected to the charger(s). When the strip is activated, power is applied to the chargers, and the current level would increase to a sufficient level to continue to supply power to the chargers. When all charging has finished, the charger(s) will go into idle mode, the current level of the charger(s) will drop below a threshold and the power to them discontinued. This eliminates the idle current of the charger(s). Other constant power outlets may also be included for other devices.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a view showing circuitry for an apparatus for controlling power distribution to subsystems in accordance with a preferred embodiment of the present invention;

FIGS. 2-3 are views showing circuitry for the inventive apparatus in accordance with a further preferred embodiment of the present invention; and,

FIG. 4 is a view showing the circuitry of FIG. 3 of the inventive apparatus in accordance with a further preferred embodiment of the present invention that includes mosfet, or metal-oxide-semiconductor field-effect transistor, as a current regulator.

### DETAILED DESCRIPTION OF THE PREFERRED EMBODIMENTS AND DRAWING FIGURES

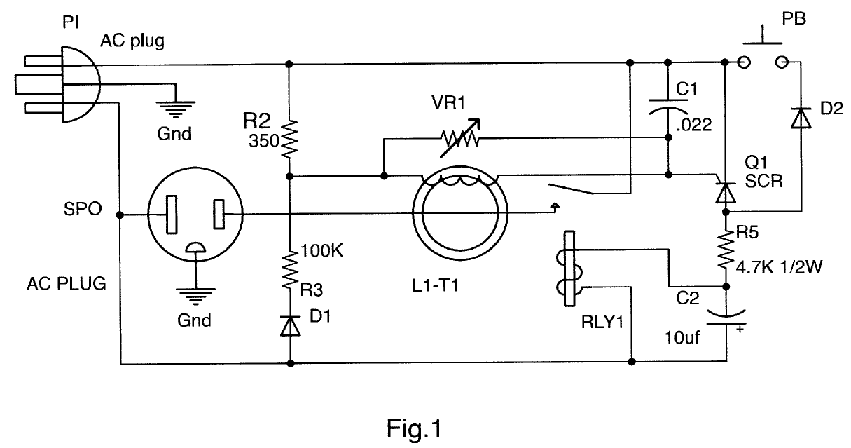

An apparatus for distributing power to subsystems in accordance with a first embodiment of the present invention, as shown in FIG. 1, has a power input (PI), which is connectable to an AC power source. A current sensing coil, or transformer (L1-T1), converts the current drawn by a main system or device connected to a main power output (SPO), into a voltage.

A voltage divider is formed by two resistors (R2 and R3), so that a small voltage is formed across the bias resistor (R2). This voltage is sufficiently small so as not to trigger the gate of the SCR (Q1). The resistors (R2 and R3) form means for increasing the voltage to provide triggering of the executing means despite the small output of the current sensing coil (L1-T1).

The bias resistor (R2) and the capacitor (C1) form a time constant to filter out line noise and prevent false triggering of the SCR (Q1).

When the push button is pressed, power is passed though a diode (D2) resistor (R5) to charge a capacitor (C2) and turn on a relay (RLY1). A charger plugged into the switched power outlet (SPO) is connected to the line power though the relay (RLY1) contacts and the current sensing coil (L1-T1). When the voltage across the current sensing coil, created by the charger's run power level, plus the voltage across the bias resistor (R2), exceeds the gate trigger voltage of the SCR (Q1), the SCR (Q1) will switch on. Current then flows through the SCR (Q1), current limiting resistor (R5), to keep the capacitor (C2) charged. The current limiting resistor (R5) limits the current to the SCR (Q1).

A diode (D1) is used to lower the power used by the voltage divider resistors (R2 and R3), but is not required.

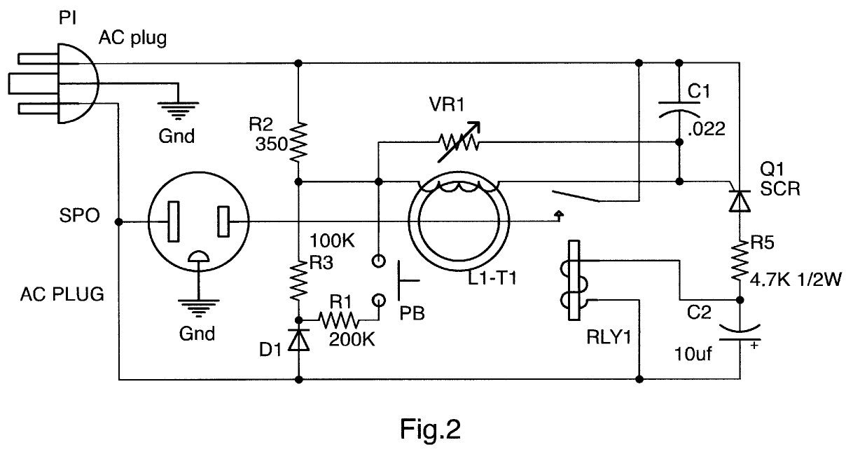

FIG. 2 shows another embodiment of the apparatus in accordance with the present invention. In this alternatively preferred embodiment, the “turn on” method is changed so when the push button is pressed, the bias voltage is across the bias resistor (R2) with the extra bias current supplied by the “turn on” resistor (R1). The extra bias is sufficiently large to turn on the SCR (Q1).

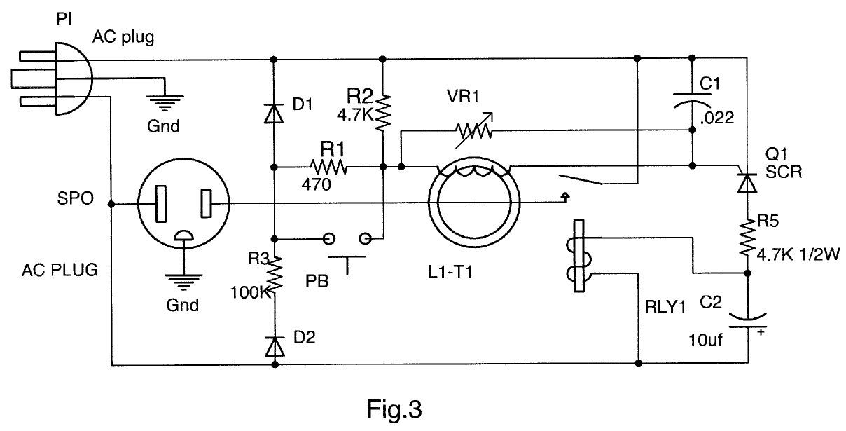

FIG. 3 shows a further embodiment of the present invention. In this alternatively preferred embodiment, the voltage divider resistors (R1 and R2) are now feed by the voltage reference formed by the diode (D1) and the resistor (R3). The resistor (R3) feeds a small current though the diode (D1) to create a 0.6-volt reference during a half cycle on the incoming AC power source. Another diode (D2) is used to protect the SCR (Q1) from reverse bias damage. The startup method is also changed. When the push button (PB) is pressed, the first resistor of the voltage divider (R1) is shorted out to increase the gate voltage of the SCR (Q1) above the triggering voltage to turn on the relay (RLY1).

It is to be understood that the apparatus in accordance with the present invention can be used on many different voltages by changing the resistor values, including, but not limited to, 100-, 120- and 220-VAC, for domestic and foreign use.

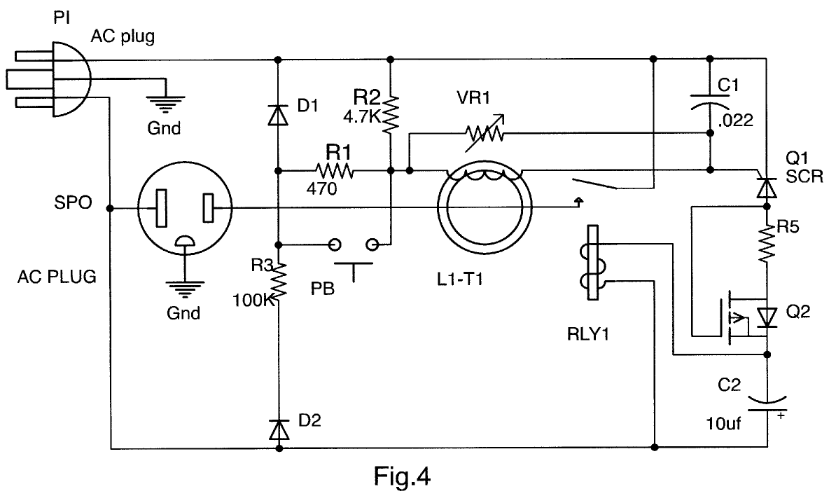

FIG. 4 shows a further embodiment of the present invention. In FIG. 4 an enhancement mosfet (Q2), or metal-oxide-semiconductor field-effect transistor, is used as a current regulator for the preferred embodiment disclosed by FIG. 3, so as to allow the embodiment of FIG. 3 to operate at from 100 to 240 VAC.

Alternatively, instead of the SCR (Q1) transistors, other switching devices may be used. Likewise, separate diodes can be used instead of the diode bridges. The reference diodes also can be replaced by any voltage reference device.

It will be understood that each of the elements described above, or two or more together, may also find a useful application in other types of constructions differing from the types described above.

It will be understood that a charger used in the examples can be replaced any device that has a run mode followed by a standby mode. (e.g., a microwave oven.)

While only several embodiments of the present invention have been shown and described, it will be obvious to those skilled in the art that many modifications may be made to the present invention without departing from the spirit and scope thereof.

What is claimed is:

1. Apparatus for controlling electrical power distribution to an electrical charging device having a run mode and a standby mode, comprising:
a power input connectable to a power source for receiving electrical current from the power source;
a power output connectable to an electrical charging device having a run mode and a standby mode for supplying the electrical current to the electrical charging device;
means for sensing when the electrical current to the electrical charging device is either above a predetermined threshold or below the predetermined threshold, the electrical current being below the predetermined threshold when the electrical charging device is in the standby mode and the electrical current being above the predetermined threshold when the electrical charging device is in the run mode;
means for interrupting the electrical current to the electrical charging device when the electrical current falls below the predetermined threshold as the electrical charging device transitions from the run mode to the standby mode as determined via said means for sensing; and,
means for resetting and powering the electrical charging device when the electrical current increases above the predetermined threshold as the electrical charging device transitions from the standby mode to the run mode as determined via said means for sensing.

2. The apparatus for controlling electrical power distribution to an electrical charging device having a run mode and a standby mode according to claim 1, wherein said means for resetting and powering the electrical charging device includes a low current operating device for increasing voltage required for triggering said means for resetting and powering.

3. The apparatus for controlling electrical power distribution to an electrical charging device having a run mode and a standby mode according to claim 2, wherein said low current operating device includes a voltage reference for preventing a triggering level change with source voltage changes.

4. The apparatus for controlling electrical power distribution to an electrical charging device having a run mode and a standby mode according to claim 1, wherein said means for resetting and powering the electrical charging device includes a voltage divider.

5. The apparatus for controlling electrical power distribution to an electrical charging device having a run mode and a standby mode according to claim 1, wherein said means for sensing when the electrical current to the electrical charge device is either above or below the predetermined threshold includes a current sensing coil or transformer.

6. The apparatus for controlling electrical power distribution to an electrical charging device having a run mode and a standby mode according to claim 1, wherein said means for resetting and powering the electrical charging device is a direct current relay.

7. The apparatus for controlling electrical power distribution to an electrical charging device having a run mode and a standby mode according to claim 1, wherein said means for resetting and powering the electrical charging device is an alternating current relay.
